(19) United States
(12) Patent Application Publication
(10) Pub. No.: US 2013/0323419 A1
(43) Pub. Date: Dec. 5, 2013

(54) METHODS FOR PREPARING POLYMER MEMBRANES ON POROUS SUPPORTS

(71) Applicant: Corning Incorporated, Corning, NY (US)

(72) Inventors: Theresa Chang, Painted Post, NY (US); David Ferrughelli, Flemington, NJ (US); Robert Randall Hancock, JR., Corning, NY (US); Trista Nicole Hesch, Campbell, NY (US); Randall D. Partridge, Califon, NJ (US); Emmanuel Ulysses, Maplewood, NJ (US)

(73) Assignee: ExxonMobil Research and Engineering Company, Annandale, NJ (US)

(21) Appl. No.: 13/907,126

(22) Filed: May 31, 2013

Related U.S. Application Data
(60) Provisional application No. 61/655,692, filed on Jun. 5, 2012.

(51) Int. Cl. B01D 61/36

(52) U.S. Cl. CPC B01D 61/366
USPC 427/243

(57) ABSTRACT

Methods for preparing a polymer membrane on a porous support may include providing a porous support having an outer wall, a first end, a second end, and porous channel surfaces that define a plurality of channels through the porous support from the first end to the second end. The plurality of channels includes membrane channels. The channel surfaces that define the membrane channels are membrane-channel surfaces. The polymer membrane may be coated onto the porous support by first establishing a pressure differential between the outer wall and the plurality of channels. Then, a pre-polymer solution may be applied to the membrane-channel surfaces and, optionally, the first and second ends, by slip coating or emulsion coating while the pressure differential is maintained. This results in formation of a pre-polymer layer on at least the membrane-channel surfaces. Then, the pre-polymer layer may be cured to form the polymer membrane.

This application claims the benefit of priority under 35 U.S.C. §119 of U.S. Provisional Application Ser. No. 61/655,692 filed on Jun. 5, 2012 the content of which is relied upon and incorporated herein by reference in its entirety.

### BACKGROUND

1. Field

The present specification generally relates to pervaporation membranes and, more specifically, to methods for coating polymeric pervaporation membranes onto porous ceramic supports.

2. Technical Background

Pervaporation is a term derived from a process including a permeation step and an evaporation step. During pervaporation, a feed such as a fluid (i.e., liquid or gas) mixture may be allowed to permeate into a membrane. The membrane may be selected such that desired components of the fluid mixture are absorbed into and transported through the membrane at a higher rate than other components of the liquid mixture. The permeated fluid may then be evaporated to desorb from the membrane and form a “permeate” that is either substantially enriched in the desired component (relative to the original liquid mixture) or is the desired component in pure form. The evaporation is typically driven by a pressure differential on opposite sides of the membrane. A portion of the feed that does not permeate through the membrane is called the “retentate.” The retentate may contain a lower amount of the desired component than the feed or may be substantially devoid of the desired component. Thus, pervaporation has become an area of growing importance and interest, especially in applications such as separations of organic-organic mixtures of azeotropic or close boiling components and also for on-board separation (OBS) of gasoline.

Commercially available polymeric materials typically are unsuitable for use as pervaporation membrane materials, owing to membrane degradation from swelling and/or loss of membrane integrity after continued use. To this end, composites containing a polymer membrane may be applied to a stable porous support such as a ceramic, for example, to provide mechanical support and resistance to thermal and chemical aging. Moreover, the permeable membranes should be vacuum-tight and leak-free to maintain selectivity toward the desired permeate, yet contain a minimum amount of polymeric material to maximize flux through a pervaporation system. Application of an optimal permeable polymeric membrane to a highly porous support remains extremely challenging, however.

Accordingly, ongoing needs exist for methods, whereby polymeric materials can be reproducibly coated onto porous supports so as to provide leak-free, vacuum-tight, high-flux, highly selective pervaporation membranes.

### SUMMARY

According to various embodiments, methods for preparing a polymer membrane on a porous support may include providing a porous support having an outer wall, a first end, a second end, and porous channel surfaces that define a plurality of channels through the porous support from the first end to the second end. The plurality of channels includes membrane channels. The channel surfaces that define the membrane channels are membrane-channel surfaces. The polymer membrane may be coated onto the porous support by first establishing a pressure differential between the outer wall and the plurality of channels. Then, a pre-polymer coating solution may be applied to the membrane-channel surfaces while the pressure differential is maintained. This results in formation of a pre-polymer layer on the membrane-channel surfaces. Then, the pre-polymer layer may be cured to form the polymer membrane.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is an illustrative embodiment of a porous support to which a polymer membrane has been applied according to methods described herein;

FIG. 2 is a detail view of a membrane channel of the porous support of FIG. 1;

FIG. 3 is a cross-sectional view of an illustrative embodiment of a coating vessel for use in applying the polymer membrane to the porous support according to the methods described herein; and

FIG. 4 is a graph of pore size distributions of various coating layers applied to a porous support, and particle-size distributions of various polymer emulsions used to prepare polymer membranes according to embodiments described herein.

### DETAILED DESCRIPTION

Reference will now be made in detail to embodiments of methods for preparing a polymer membrane on a porous support. In some embodiments, the methods may include providing a porous support having an outer wall, a first end, a second end, and porous channel surfaces that define a plurality of channels through the porous support from the first end to the second end. The plurality of channels includes membrane channels. The channel surfaces that define the membrane channels are membrane-channel surfaces. The polymer membrane may be coated onto the porous support by first establishing a pressure differential between the outer wall and the plurality of channels. Then, a pre-polymer coating solution may be applied to the membrane-channel surfaces and, optionally, to the first end and the second end, while the pressure differential is maintained. This results in formation of a pre-polymer layer on the membrane-channel surfaces and, optionally, on the first end and the second end. Then, the pre-polymer layer may be cured to form the polymer membrane.

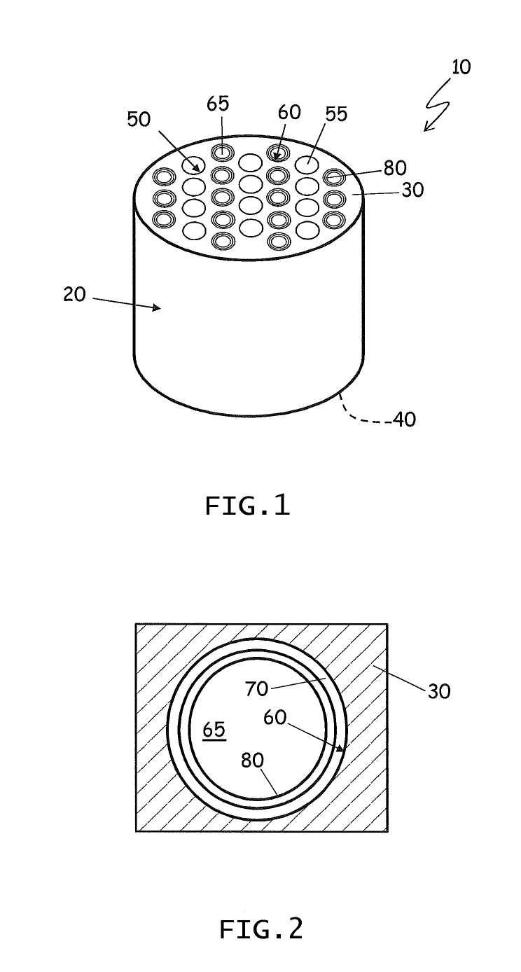

An illustrative embodiment of the porous support 10 is provided in FIG. 1. To differentiate the membrane channels 65, the porous support 10 of FIG. 1 is shown with the polymer membrane 80 already present after having been applied by the methods described herein. The porous support 10 may have an outer wall 20, a first end 30, and a second end 40. The porous support also contains porous channel surfaces 50, 60 that define a plurality of channels 55, 65 that extend through the porous support 10 from the first end 30 to the second end 40. The plurality of channels 55, 65 includes membrane channels 65. The porous channel surfaces 50, 60 that define the membrane channels 65 are membrane-channel surfaces 60. In some embodiments the plurality of channels 55, 65 may include non-membrane channels 55. In some embodiments, all of the channels 55, 65 may be membrane channels 65. It should be understood that the configuration of the membrane channels 65 among the non-membrane channels 55 in FIG. 1 is meant to be illustrative only and that the membrane channels 65 may be arranged among the non-membrane channels 55 (if present) in any desired manner.

In some embodiments, as in the embodiment of FIG. 1, the porous support 10 may be in the form of a honeycomb monolith. The porous support 10, such as a honeycomb monolith, may have a channel density of, for example, from 50 to 600 cells per square inch. Nevertheless, it is contemplated that the porous support 10 may have a channel density less than 50 cells per square inch or greater than 600 cells per square inch. Examples of honeycomb monoliths also suitable for embodiments of the methods described herein are disclosed in U.S. Pat. Nos. 3,885,977 and 3,790,654, the contents of both being incorporated herein by reference.

To allow for more intimate contact between a fluid stream flowing through the support and the porous support 10 itself, for example when used in a separation application, in certain embodiments not shown it may be desirable that at least some of the channels 55, 65 be plugged at one end of the porous support 10, while other channels are plugged at the other end of the porous support 10. In certain embodiments, may be desired that at each end of the porous support 10, the plugged and/or unplugged channels form a checkerboard pattern with each other. In certain embodiments, it may be desired that where one channel is plugged on one end (referred to as “the reference end”) but not the opposite end of the porous support 10, at least some, for example a majority, of the channels (or all of the channels in certain other embodiments) immediately proximate thereto (those sharing at least one wall with the channel of concern) be plugged at such opposite end of the porous support 10 but not on the reference end. Furthermore, individual porous supports such as honeycombs can be stacked or housed in various manners to form larger porous supports having various sizes, service duration, and the like, to meet the needs of differing use conditions.

In one embodiment, the porous support 10 may be an inorganic material. Suitable inorganic porous support materials include, for example, ceramics, glass ceramics, glasses, metals, clays, and combinations thereof. Some illustrative materials include, for example, cordierite, mullite, clay, magnesia, metal oxides, talc, zircon, zirconia, zirconates, zirconia-spinel, magnesium alumino-silicates, spinel, alumina, silica, silicates, borides, alumino-silicates, porcelains, lithium aluminosilicates, alumina silica, feldspar, titania, fused silica, nitrides, borides, carbides such as silicon carbide, silicon nitride, or combinations of any of these. In some embodiments, the porous support 10 may be a ceramic selected from cordierite, alpha-alumina, mullite, titania, zirconia, ceria, and combinations thereof.

The porous support 10 may have any of a wide range of porosities and pore sizes on the channel surfaces 50, 60 that define channels 55, 65. In one embodiment, the pores of the channel surfaces 50, 60 before the polymer membrane 80 is applied may have a median pore size of from 0.5 μm to 100 μm, for example from 0.5 μm to 10 μm. The channel surfaces 50, 60 may have porosities, prior to being coated with any coating layer, of from 30% to 60%, for example, as measured by mercury intrusion porosimetry.

In some embodiments, the porous support 10 may have any shape or size and may be formed from any solid, porous material onto which a coating layer, such as the polymer membrane 80, can be coated or applied. The porous support 10 may be formed, extruded, or molded, for example. Though the porous support 10 in FIG. 1 is shown as cylindrical, it should be understood that this is for illustrative purposes only, not by way of limitation. In further illustrative embodiments, the porous support 10 may have lengths up to 12 inches (30.5 cm) and outer diameters of from 1 inch (2.54 cm) to 3 inches (7.62 cm), for example. Further embodiments of shapes for the porous support 10 include not only cylinders but also, without limitation, shapes with cross sections such as ovals, hexagons, pentagons, rectangles, squares, rhombuses, triangles, or even irregular shapes. In some embodiments, the porous support 10 may be a filter such as, for example, a honeycomb filter.

In some embodiments, the porous support 10 may contain any number of channels 55, 65, from a single channel to thousands of channels. In some embodiments, the channels 55, 65 may have various cross-sectional shapes, such as circles, ovals, triangles, squares, pentagons, hexagons, or tessellated combinations or any of these, for example, and may be arranged in any suitable geometric configuration. The channels 55, 65 may have various dimensions or diameters that may be the same or different within the porous support 10 itself. In exemplary embodiments, the porous support 10 may be a cylindrical or oval cordierite honeycomb monolith having channels 55, 65 that are circular, oval, or hexagonal.

The methods for preparing a polymer membrane 80 on a porous support 10 include depositing the polymer membrane 80 onto the porous support 10. In some embodiments, depositing the polymer membrane 80 onto the porous support 10 includes establishing a pressure differential between the outer wall 20 of the porous support 10 and the plurality of channels 55, 65 and then applying a pre-polymer coating solution to the membrane-channel surfaces 60 while maintaining the pressure differential. In some embodiments, the pre-polymer coating solution may also be applied to the first end 30 and the second end 40. The result is a pre-polymer layer formed on the membrane-channel surfaces 60 and, optionally, also the first end 30 and the second end 40. Then, the pre-polymer layer may be cured to form the polymer membrane 80. Optionally, one or more additional layers such as a precoat 70 may be applied to at least the membrane-channel surfaces 60 before the polymer membrane 80 is deposited and cured.

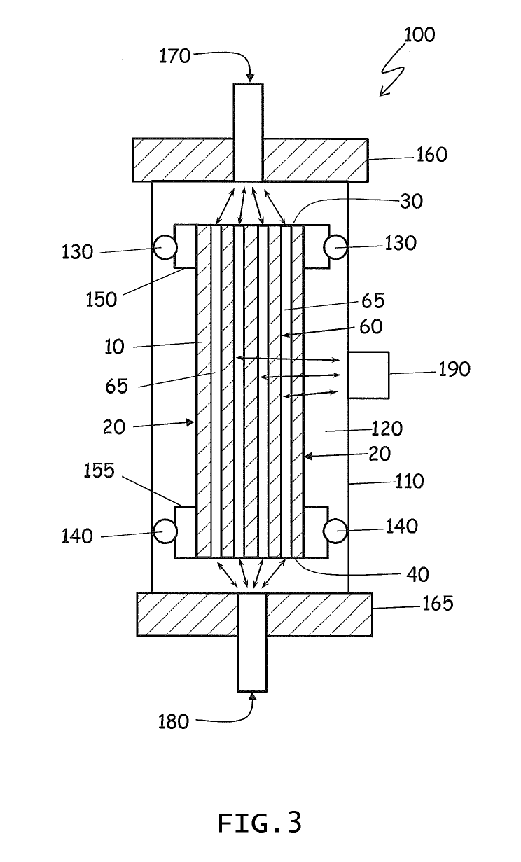

Referring to FIG. 3, according to some embodiments, establishing the pressure differential may include placing the porous support 10 in a coating vessel 100 having a chamber 120 defined therein. It should be understood that the coating vessel 100 of FIG. 3 is shown in cross-section with the porous support 10 placed therein. The coating vessel 100 may include a vessel wall 110 extending from a first end plate 160 to a second end plate 165, such that the vessel wall 110, the first end plate 160, and the second end plate 165 enclose the porous support 10. The chamber 120 may be defined between a first seal 130 at the first end 30 of the porous support 10 and a second seal 140 at the second end 40 of the porous support 10. Though in preferred embodiments the coating vessel 100 may be oriented vertically, as shown in FIG. 3, it should be understood that the coating vessel 100 may be oriented otherwise, such as horizontally, for example.

In the embodiment of FIG. 3, the first seal 130 and the second seal 140 are rings of a suitable material such as rubber. The first seal 130 may be seated in a first seal seat 150 adapted to form a vacuum-tight seal around the outer wall 20 of the porous support 10 near the first end 30 of the porous support 10. Likewise, the second seal 140 may be seated in a second seal seat 155 adapted to form a vacuum-tight seal around the outer wall 20 of the porous support 10 near the second end 40 of the porous support 10. Optionally, the vacuum-tight seals of the first seal seat 150 and the second seal seat 155 may be facilitated by applying a sealing material such as a caulk along any edges where the seal seats 150, 155 contact the outer wall 20 of the porous support 10. The first seal 130 and the second seal 140 contact the vessel wall 110 of the coating vessel 100.

During the deposition of the polymer membrane 80, at least a portion of the outer wall 20 of the porous support 10 is disposed in the chamber 120, and both the first end 30 and the second end 40 of the porous support 10 are outside the chamber 120. Thereby, the portion of the outer wall 20 is isolated from the first end 30 and the second end 40, such that fluidic communication between the plurality of channels 65 and the chamber 120 can occur only through the outer wall 20, as illustrated in FIG. 3. This fluidic communication between the plurality of channels 65 and the chamber 120 may be made possible as long as the channel surfaces 60 of the plurality of channels 65 retain some porosity and may be cut off when a sufficiently vacuum-tight polymer membrane is disposed on the channel surfaces 60 and, optionally, on the first end 30 and the second end 40.

The coating vessel 100 may include a first port 170 associated with the first end 30 of the porous support 10 and a second port 180 coupled to the second end 40 of the porous support 10, such that fluidic communication between the first port 170 and the second port 180 occurs directly through the plurality of channels 65. The coating vessel 100 may further include a third port 190 associated with the chamber 120, such that fluidic communication between the third port 190 and the first and second ports 170, 180 occurs only through the outer wall 20 of the porous support 10. In some embodiments, coating materials and/or washing solvents may be introduced into the plurality of channels 65 through the first port 170 or from the second port 180. A vacuum or a backpressure may be applied to the chamber 120 using a suitable pump (not shown) or pressurized gas source (not shown) connected to the third port 190. Thereby, the pressure differential between the outer wall 20 and the plurality of channels 65 may be established when coating solutions such as a pre-polymer coating solution are applied to the membrane-channel surfaces 60, as described in greater detail below. The coating vessel 100 configured as in FIG. 3 is suitable for coating not only the channel surfaces 60, but also the first end 30 and the second end 40.

The methods for preparing the polymer membrane 80 may further include applying a pre-polymer coating solution to the membrane-channel surfaces 60 while maintaining the pressure differential between the outer wall 20 and the plurality of channels 65 to form a pre-polymer layer on the membrane-channel surfaces 60 and, optionally, the first end 30 and the second end 40. In some embodiments, the pre-polymer coating solution may be applied by slip coating. In other embodiments, the pre-polymer coating solution may be applied by emulsion coating. The pre-polymer coating solutions now will be described. The two coating application methods will be described below.

In some embodiments, the pre-polymer coating solution may be selected from various monomers or oligomers that cure to form the polymer membrane 80. In this regard, the pre-polymer coating solution may contain monomers or oligomers capable of forming a uniform coating on the membrane-channel surfaces 60 and, optionally, the first end 30 and the second end 40. In preferred embodiments, the pre-polymer coating solution does not substantially penetrate into pores of the membrane-channel surfaces 60, so as to maintain sufficient porosity between the channels, where permeation may take place in applications such as pervaporation, for example. In illustrative embodiments, the pre-polymer coating solution may contain monomers or oligomers that, when cured, form polymer materials such as poly(vinyl butyral) resins, polyacrylates, polynitriles (including carboxylated-acrylonitrile-co-butadienes), polychloroprene (neoprene), poly(vinyl chloride), poly(vinylidene fluoride), polyolefins such as polyethylene or polypropylene, poly(tetrafluoroethylene), silicones, polyurethanes, epoxy resins, poly(vinyl alcohols), polysiloxanes, polysaccharides such as celluloses, composites containing one or more of these, and mixtures of two or more of these, for example. The materials of the illustrative embodiments are especially well-suited for use on honeycomb substrates made from ceramic such as zeolites, cordierite, silicon carbide (SiC), aluminum titanate, mullite, spinel, perovskites, silicates, carbon, or alumina and mixtures thereof, for example.

In preferred embodiments, the pre-polymer coating solution may contain monomers or oligomers capable of forming cross-linked polymer membranes. For example, the pre-polymer coating solution may contain mixtures of epoxides and diamines that form crosslinked epoxy-amine polymers. In one exemplary embodiment, the pre-polymer coating solution may contain an epoxy-diamine mixture such as DENO/D400, comprising 1,2,7,8-diepoxyoctane (DENO) and O,O′-bis(2-aminopropyl)polypropylene glycol (D400).

In some embodiments it may be desirable to incorporate functionalized microparticles or nanoparticles into the pre-polymer coating solution. For example, to avoid a need for multiple applications of the pre-polymer layer to build up a defect-free polymer membrane, microparticles of aminated silica (i.e., SiO₂ microparticles functionalized with one or more groups —NH₂) may be added to a polymer precursor such as DENO/D400 to repair cracks and defects. In an exemplary embodiment, the aminated silica may contain silica with nominal particle sizes of from about 0.01 μm to about 0.05 μm, functionalized with an amine by reacting the silica particles with a silane such as aminopropyldimethylethoxysilane (“APDMES”). In such embodiments, the silica particles may be effectively filtered out in the defective areas and then bound into the cross-linked polymer network when the pre-polymer layer is cured. In turn, this binding of the silica particles to the polymer network may effect a seal while simultaneously minimizing additional buildup of polymer material on the surface of the polymer membrane 80. Minimal buildup of polymer may be desirable to avoid decrease in flux capacity of the coated porous support.

As described above, the pre-polymer coating solution may be applied by slip coating or by emulsion coating. When the pre-polymer coating solution is to be applied by slip coating, in some embodiments the pre-polymer coating solution contains only the monomers or oligomers of the material that forms the polymer membrane when cured, at least partially dissolved in an appropriate organic solvent. In some embodiments, the organic solvent may be a water-immiscible solvent such as toluene, for example.

In embodiments in which the pre-polymer coating solution is to be applied by emulsion coating, the pre-polymer coating solution may be prepared as an oil-in-water emulsion. The oil-in-water emulsion may contain an aqueous phase, an oil phase dispersed in the aqueous phase and containing a polymer precursor (i.e., the monomers or oligomers that form the polymer membrane 80 when cured), and a surfactant. In some embodiments, the oil-in-water emulsion may be prepared by adding a surfactant and an aqueous phase to a pre-polymer coating solution such as those described above for applying the pre-polymer layers by slip coating. The aqueous phase may contain a mixture of water and one or more water-soluble or water-miscible organic solvents, or the aqueous phase may consist of water, preferably deionized water. The oil phase may consist essentially of the polymer precursor or may contain the polymer precursor at least partially dissolved in a water-immiscible organic solvent such as toluene, for example. The surfactant may be any type of surfactant, such as an anionic surfactant, a cationic surfactant, a nonionic surfactant, or a mixture thereof, for example, that facilitates the formation of an oil-in-water emulsion of the oil phase in the aqueous phase.

In some embodiments, the oil-in-water emulsion may contain from about 0.1 wt. % to about 10 wt. % oil phase, preferably from about 1 wt. % to about 8 wt. % oil phase, for example about 3.0 wt. %, about 4.0 wt. %, or about 5.0 wt. % oil phase, based on the total weight of the oil-in-water emulsion. In some embodiments, the oil phase may include from about 10 wt. % to about 50 wt. % polymer precursor in organic solvent, or from about 15 wt. % to about 35 wt. % polymer in organic solvent, for example 20 wt. % or 25 wt. % or 30 wt. % polymer precursor in organic solvent, based on the total weight of the oil phase. In some embodiments, the oil-in-water emulsion may contain from about 0.01 wt. % to about 20 wt. %, or from about 0.05 wt. % to about 10 wt. %, or from about 0.1 wt. % to about 0.5 wt. % surfactant, based on the total weight of the oil-in-water emulsion. One example of a suitable surfactant is sodium dodecyl sulfate (SDS). In an illustrative embodiment, the oil-in-water emulsion may contain from about 2 wt. % to about 6 wt. % of an oil phase including about 15 wt. % to about 35 wt. % DENO/D400 oligomers dissolved in toluene (based on the total weight of the oil phase); from 0.1 wt. % to 10 wt. % SDS; and a balance to 100 wt. % of deionized water. In a preferred embodiment, the oil-in-water emulsion may contain about 4 wt. % of an oil phase including about 25 wt. % DENO/D400 oligomers and about 75 wt. % toluene (based on the total weight of the oil phase); about 0.1 wt. % to about 5 wt. % of a surfactant such as SDS (for example, from 0.1 wt. % to 0.5 wt. %, from 0.2 wt. % to 1.0 wt. %, from 0.3 wt. % to 1.0 wt. %, about 0.3 wt. % SDS, about 0.4 wt. % SDS, or about 0.5 wt. % SDS); and a balance to 100 wt. % of deionized water.

The oil phase of the oil-in-water emulsion may contain particles having median particle sizes of from 0.1 μm to 500 μm or from 0.1 μm to 300 μm, or from 0.8 μm to 100 μm, for example. In some embodiments, the median particle sizes may be from 1 μm to 20 μm. Without intent to be bound by theory, it is believed that the choice of surfactant in the oil-in-water emulsion, along with the amount of surfactant added to the oil-in-water emulsion, may highly influence the particle sizes. As a result, the particle sizes in the oil-in-water emulsion may be tailored to approximate the pore sizes of the membrane-channel surfaces to which the pre-polymer coating solution is being applied. In some embodiments, the membrane-channel surfaces may have a membrane-channel pore-size distribution, and the oil-in-water emulsion may be tailored such that oil-phase particles in the oil-in-water emulsion may have an oil-phase particle size distribution substantially overlapping the membrane-channel pore-size distribution. In this regard, “substantially overlapping” means that at least 20% of the total area under oil-phase particle size distribution curve and the membrane-channel pore-size distribution curve is area in which the two size distribution curves overlap. In some embodiments, the oil-in-water emulsion may contain from about 0.1 wt. % to about 15 wt. % surfactant, or from 0.2 wt. % to about 10 wt. % surfactant, or from about 0.5 wt. % to about 10 wt. % surfactant, or from about 0.5 wt. % to about 5 wt. % surfactant, based on the total weight of the oil-in-water emulsion.

In some embodiments, the oil-in-water emulsion may contain an ethoxylated nonionic surfactant of the formula R(OC₂H₄)ₙOH, wherein R is selected from the group consisting of aliphatic hydrocarbon radicals containing from about 8 to about 15 carbon atoms and alkyl phenyl radicals in which the alkyl group contains from about 8 to about 12 carbon atoms, n is from about 3 to about 9. Suitable ethoxylated nonionic surfactants are the condensation products of alkyl phenols having an alkyl group containing from about 8 to about 15 carbon atoms, in either a straight chain or branched chain configuration, with ethylene oxide, the ethylene oxide being present in amounts equal to from about 3 to about 9 moles of ethylene oxide per mole of alkyl phenol. Other useful nonionic surfactants include condensation products of primary or secondary aliphatic alcohols with from about 3 to about 9 moles of ethylene oxide per mole of alcohol. The alkyl chain of the aliphatic alcohol can either be straight or branched and contains from about 8 to about 15 carbon atoms.

In some embodiments, the surfactant may include ethoxylated nonionic surfactants such as: (1) the condensation products of ethylene oxide with a hydrophobic base formed by the condensation of propylene oxide and propylene glycol, and/or (2) the condensation products of ethylene oxide with the product resulting from the reaction of propylene oxide and ethylenediamine. These surfactants are marketed by BASF Wyandotte under the tradenames Pluronic® and Tetronic® respectively.

The oil-in-water emulsion may have a wide range of viscosities such as from 50 cP to 5000 cP at 25° C. Except as noted otherwise, viscosities herein refer to those measured using a Brookfield viscometer with an LVF No. 3 spindle spinning at 30 r.p.m. at 25° C. In some embodiments, the oil-in-water emulsion may have a solids content of from 0.1 wt. % to 10 wt. %, such as from about 1 wt. % to about 5 wt. % by weight, based on the total weight of the emulsion. As used here, the term “solids content” means the weight of the polymer precursor, based on the total weight of the oil-in-water emulsion.

Without intent to be bound by theory, it is believed that applying the pre-polymer coating solution by emulsion coating according to embodiments described above results in only oil-phase particles having sufficient size and stability being retained by the membrane-channel surfaces, while other particles (such as smaller or less stable oil phase particles, for example,) pass through the pores of the membrane-channel surfaces and through the porous support 10. Because the oil-phase particles are generally incompatible with the ceramic particles already on the membrane-channel surfaces, very little deposition of the pre-polymer coating solution may occur. In some embodiments, the oil-in-water emulsion may be diluted by adding water to the membrane channels after the oil-in-water solution is passed through. It is believed the dilution may aid the formation of a more uniform pre-polymer layer and also may dilute the relative concentration of the surfactant to the amount of the oil phase. When the surfactant is washed away, it is believed that the oil-in-water emulsion may destabilize on the membrane-channel surface, causing the oil phase to merge and form a uniform film. It is believed that once the oil phase merges, it is unlikely for the oil phase to return to the aqueous phase, because of oil-water phase incompatibility.

To apply the pre-polymer layer by slip coating, in some embodiments the membrane channels 65 may be filled with the pre-polymer coating solution through the second port 180 (for example, against gravity, from the bottom up). During the application by slip coating, the pressure differential between the outer wall 20 and the plurality of channels 65 may be maintained by applying a backpressure of from about 5 kPa to about 80 kPa, or from about 10 kPa to about 60 kPa, through the third port 190 of the coating vessel 100. The backpressure may be applied by connecting the third port 190 to a compressed gas source (not shown) such as a source of nitrogen or other inert gas, for example. Without intent to be bound by theory, it is believed that the backpressure may force liquid components of the pre-polymer coating solution into the porous support 10 so as to leave solid components of the pre-polymer coating solution on the membrane-channel surfaces 60, avoiding also any infiltration of the pre-polymer coating solution into the membrane-channel surfaces 60 that may adversely result in decreased flux capacity from a thicker polymer membrane.

The slip coated pre-polymer coating solution may be allowed to soak into at least the membrane-channel surfaces 60 for a suitable time such as 30 seconds to 5 minutes, for example, after which the pre-polymer coating solution may be drained from the membrane channels 65 through the second port 180. Optionally, a brief vacuum (5 seconds to 2 minutes, for example) may be applied through the first port 170 or the second port 180 to remove any excess pre-polymer coating solution from the membrane channels 65. In some embodiments, the membrane channels 65 may be prefilled with an aqueous or organic solvent before the pre-polymer coating solution is introduced. Without intent to be bound by theory, it is believed that solvent prefilling may prevent substantial infiltration of the pre-polymer coating solution into pores or voids in the membrane-channel surfaces 60 and thereby retain high flux capacity in the polymer membrane 80.

To apply the pre-polymer layer by emulsion coating, in some embodiments the membrane channels 65 may be filled through the first port 170 (for example, aided by gravity, from the top down) with a pre-polymer coating solution that is an emulsion, described in greater detail below. Optionally, while the membrane channels 65 are filled, one or both of the first end 30 and the second end 40 may be exposed to pre-polymer coating solution to form a pre-polymer layer on the membrane channels 65, the first end 30, and the second end 40. In contrast with the slip coating procedure described above, during the emulsion coating the pressure differential between the outer wall 20 and the plurality of channels 65 may be maintained by applying a vacuum of from about −5 kPa to about −100 kPa, or from about −10 kPa to about −50 kPa, through the third port 190 of the coating vessel 100. Without intent to be bound by theory, it is believed that the application of a vacuum in this manner may pull aqueous components of the polymer emulsion into pores of the membrane-channel surfaces, whereupon they travel through the outer wall 20 of the porous substrate 10 and into the chamber 120. In some embodiments, the filling of the membrane channels 65 with the pre-polymer coating solution (i.e., the polymer emulsion), may be followed by flushing the membrane channels 65 with water. The membrane channels may be vacuum dried to remove any residual water, such as by maintaining the vacuum through the third port 190, by creating a separate vacuum through the membrane channels 65 (e.g., from the first port 170 and the second port 180), or both.

The methods for preparing a polymer membrane on a porous support may further include curing the pre-polymer layer to form the polymer membrane. In some embodiments, the pre-polymer layer may be cured by thermal treatment, such as by heating the porous support to a curing temperature of from about 120° C. to about 180° C., depending on the material chosen as the polymer membrane. The curing may occur over a curing time from about 2 hours to about 24 hours, also depending on the material chosen as the polymer membrane. In some embodiments, the curing may be conducted in an inert atmosphere such as nitrogen. Once the curing of the polymer membrane is complete, the coated porous substrate may be tested for vacuum-tightness and mass gain. These are useful figures of merit because pervaporation performance, for example, may be governed by the selectivity of the polymer membrane and the flux through the polymer membrane. These parameters may depend heavily on control of the polymer membrane deposition process. In general, the vacuum-tightness of the coated porous membrane may be directly related to its selectivity in pervaporation applications. The mass gain may be related to the thickness of the polymer membrane and the amount of polymer material (if any) that may have infiltrated into pores of the membrane-channel walls. Thereby, the mass gain may also predict the flux capacity of the coated porous support.

In some embodiments, if the vacuum-tightness is found to be below an optimal level for using the coated polymer membrane in a desired application such as pervaporation, for example, one or more additional layers of polymer membrane may be applied over the existing polymer membrane. The one or more additional layers may be defect-repair layers that plug any defects such as pinholes in the polymer membrane. The one or more additional layers may be formed by repeating the steps of applying a pre-polymer coating solution to form a pre-polymer layer (a defect-repair layer), and curing the pre-polymer layer (the defect repair layer) to increase the thickness and vacuum-tightness of the polymer membrane, thereby forming a repaired polymer membrane. In some embodiments, during the application of the one or more defect-repair layers, the step of establishing a pressure differential may be preferred but is generally optional. Though in some embodiments a single layer of polymer membrane applied according to the methods described herein may provide a suitably vacuum-tight polymer membrane, in other embodiments optimal vacuum-tightness may be achieved after from 2 to 10 depositions. Even so, it should be recognized that the benefits of increasing the thickness of the polymer membrane by multiple depositions may be counterbalanced by any potential for decreasing the flux capacity of the coated porous support in its intended application. In some embodiments, when additional layers are applied, a pressure differential such as backpressure (for slip coatings) or applied vacuum (for emulsion coatings) may be established as needed, depending on how vacuum-tight the polymer membrane 80 already is when the additional layers are applied.

Further embodiments of methods for preparing the polymer membrane 80 on the porous support 10 may include applying a precoat layer 70 (see FIG. 2) to the membrane-channel surfaces 60 and, optionally, the first end 30 and the second end 40, before establishing the pressure differential and applying the pre-polymer coating solution. The precoat layer may have a precoat average pore size less than the average pore size of the channel surfaces of the porous support. In general, it is believed that preparing the polymer membrane 80 on a surface having a smaller pore size than that of the as-provided porous support may facilitate formation of a more uniform polymer membrane less susceptible to pin-hole defects that may compromise vacuum-tightness.

While the average pore size of the channel surfaces of the as-provided porous support may range from about 0.5 μm to 100 μm, for example, if a precoat layer 70 is applied, the precoat average pore size may range from about 0.3 μm to about 1 μm, thereby providing a less porous surface more amenable to the application of a vacuum-tight polymer membrane thereon. It is also believed that the application of a precoat layer 70 may facilitate the ability to provide a vacuum-tight polymer membrane 80 with ideal thicknesses such as less than 20 μm, for example, to retain the flux capacity of the membrane channels 60. In particular, the thickness of the polymer membrane controls the flux capacity of the membrane channels 60, and if the polymer membrane 80 is too thick, the amount of permeate that can through the membrane-channel walls 65 may be substantially diminished in applications such as pervaporation, for example. Thus, the smaller inorganic pore size afforded by the precoat layer 70 may enable sealing of the membrane-channel walls 65, at least in part by preventing substantial infiltration of the polymer of the polymer membrane 80 into the porous support 10. In general, the infiltration of the polymer can lead to disadvantageously thick polymer membranes (such as greater than 20 μm) that result in porous supports with little flux.

In some embodiments, the precoat layer 70 may be applied by slip coating. The slip coating may be accomplished using the coating vessel 100 described above or may be accomplished by any other conventional technique. In general, slip coating of the precoat layer 70 may include preparing a coating slip as a dispersion, slurry, or suspension of inorganic particles in a carrier liquid, for example. The carrier liquid may be aqueous or organic. The coating slip optionally may contain additional ingredients such as dispersants, lubricants, plasticizers, binders, anti-cracking agents, anti-foaming agents, or mixtures thereof.

A wide variety of inorganic particles may be used in the coating slip for the precoat layer 70, including, but not limited to cordierite, alumina (such as alpha-alumina and gamma-alumina), mullite, aluminum titanate, titania, zirconia, and ceria particles and combinations thereof. The size of the inorganic particles may be selected depending on the pore size of the porous support. For example, the inorganic particles may have a median particle size of from 0.02 μm to 10 μm. In some embodiments, the coating slip may contain from 0.1 wt. % to 50 wt. % inorganic particles, based on the total weight of the coating slip. In general, it is believed that higher inorganic particle concentrations may produce a thicker, more viscous slip, which in turn tends to produce a thicker precoat layer on the porous support. The coating slip may also comprise, for example, a dispersant, a binder, an anti-cracking agent, an anti-foam agent, or combinations thereof, and may comprise an aqueous or organic carrier and be in the form of a slurry or suspension.

Embodiments have been described of various methods for preparing a polymer membrane on a porous support. The polymer membranes prepared according to one or more embodiments described above may be reproducibly prepared and may have characteristics amenable to applications such as pervaporation, that require coated porous support that are substantially leak-free, vacuum-tight, high-flux, and highly selective. Thus, additional embodiments include coated porous supports prepared by any of the methods described herein for preparing a polymer membrane on a porous support. Further embodiments include pervaporation systems or apparatus that include at least one coated porous supports prepared by any of the methods described herein for preparing a polymer membrane on a porous support.

### EXAMPLES

The embodiments described herein will be further clarified by the following examples.

### Example 1

### Preparation of Pre-Polymer Emulsion Solution

For use in an emulsion deposition, a pre-polymer coating solution was prepared. A polymer precursor solution was prepared that contained 25 wt. % of DENO/D400 oligomers dissolved in toluene. Then, 8 g of the polymer precursor solution was combined with 10 g of aqueous 10 wt % sodium dodecyl sulfate (SDS) solution. The mixture was shaken and vortexed to form a white, viscous paste, then the mixture was diluted with 182 g of deionized water, resulting in 200 mL of a pre-polymer coating solution that contained 0.5 wt. % SDS and 4 wt. % organic phase. A magnetic stir bar was added, and the emulsion was stirred vigorously for 3 to 16 hours before being used to coat a porous support.

### Example 2

### Effect of Surfactant Content on Emulsion-Coated Polymer Membranes

Polymer membranes of DENO/D400 were prepared on porous supports in the coating vessel of FIG. 3 using emulsions prepared as described in Example 1. Specifically, emulsions containing 0.1 wt. % SDS, 0.5 wt. % SDS, and 5.0 wt. % SDS were tested to evaluate the effect of surfactant content in the emulsion on the quality of the polymer membrane. The emulsion coatings were applied to two precoated porous supports with average pore sizes of 0.2 μm and 0.01 μm. The average pore sizes of 0.01 μm and 0.2 μm were attained by slip coating precoat layers of different particle sizes onto a bulk as-received porous support.

The membrane channels of the porous supports were filled from top to bottom with the emulsion, and the emulsion was allowed to filter through the porous support. The porous support was allowed to dry by letting it sit at room temperature (25° C.) for 16 hours, after which a vacuum test was performed to evaluate the coating. As shown in Table 1, it was found that while the 0.1 wt. % SDS and the 5 wt. % SDS emulsions resulted in polymer membranes with only a moderate level of vacuum-tightness, the emulsion stabilized with 0.5 wt. % SDS provided an exceptionally level of vacuum tightness. Although all three emulsions were milky white, it was noted that the 0.5 wt. % SDS emulsion was consistently more opaque than the other two.

TABLE 1

| Sample | SDS content in emulsion | Mass gained | Vacuum test |
|---|---|---|---|
| 1 | 0.1 wt. % | 0.236 g | Pull to −35 kPa |
| 2 | 0.5 wt. % | 0.149 g | Pull to −80 kPa |
| 3 | 5.0 wt. % | 0.137 g | Pull to −35 kPa |

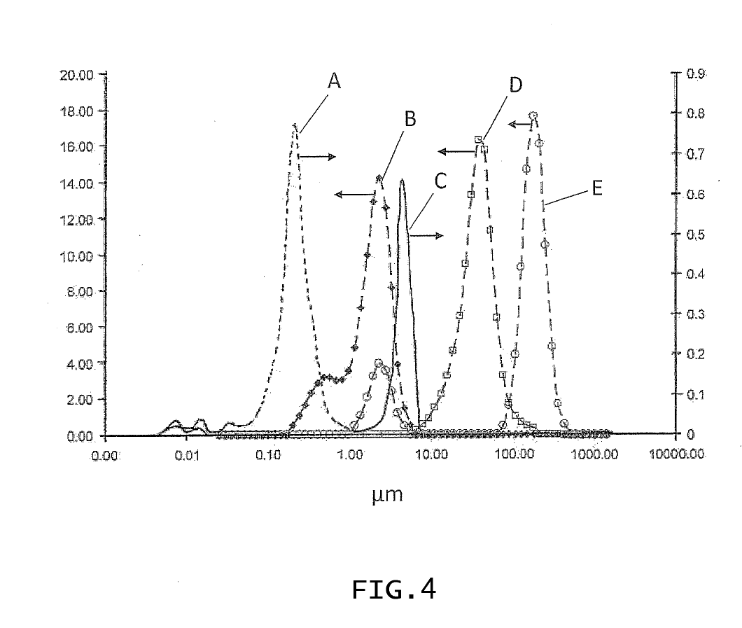

Without intent to be bound by theory, it is believed that the particle sizes of the oil phase in the emulsions may correlate with the vacuum-tightness of the resultant polymer membranes. Particle size analyses were performed. As shown in FIG. 4, the particle size analyses indicated that the emulsion particle size distribution of the 0.5 wt. % SDS emulsion (peak B) was centered around about 2 μm, while the emulsion particle size distribution of the 0.1 wt. % SDS emulsion (peak C) and the 5 wt. % SDS emulsion (peak D) were centered around about 30 μm and about 100 μm, respectively. It was noted that the emulsion particle size distribution of the 0.5 wt. % SDS emulsion (peak B) substantially overlapped the pore size distribution of the precoat layer (peak C) applied to the 0.2-μm porous support.

The porous supports with the average pore size of 0.01 μm sealed much in the same way as did the porous supports with the average pore size of 0.2 μm, with the 0.5 wt. % SDS emulsion showing increased vacuum-tightness. Although the surfaces of the 0.2-μm supports were much rougher than those of the 0.01-μm supports, the results were similar to that of the 0.2 μm supports, presumably because of similarities in pore size distribution. Note from FIG. 4 that the pore-size distribution of the 0.01-μm supports (peak A) also substantially overlaps with the emulsion particle size distribution of the 0.5 wt. % SDS emulsion (peak B), particularly through the broad centering around 0.3 μm.

### Example 3

### Slip Coated Polymer Membranes

Additional DENO/D400 polymer membranes were applied by slip coating to porous supports having average pore sizes of 0.2 μm and 0.01 μm. Channels of the porous supports were filled from the bottom up with the pre-polymer coating solution coating slip (12.5 wt. % DENO/D400 in toluene). A backpressure of about 60 kPa was applied from the outer walls into the channels. The coating slip was retained in the channels for 2 minutes and then drained. A brief vacuum (10 seconds) was applied to expel excess coating solution from the channels. The porous support was removed from the coating vessel, allowed to dry overnight (16 hr) and cured at 150° C. (4-18 hours, in nitrogen). The porous supports were checked for mass gain and vacuum-tightness of the polymer membrane.

### Example 4

### Characterization of DENO/D400 Polymer Membranes

Various polymer membranes prepared in Examples 2 and 3 were characterized. By SEM, the polymer membranes were shown to be a continuous film on the channel walls, with little evidence of infiltration throughout the bulk of the ceramic. The polymer membrane thickness after one emulsion treatment was around 1 μm to 2 μm on the 0.2-μm micron porous support. On a rougher precoated sample, some polymer infiltration was evident, presumably because of the increase in surface roughness.

Polymer membranes coated using a first emulsion coat were found to be stable and moderately selective to aromatic compounds (gasoline) over ethanol, but the selectivity was found to be lower than that of polymer membranes formed using slip coating. The decreased selectivity from the emulsion-coated membranes may arise from unconstrained swelling (when the membrane comes in contact with gasoline), because the membrane lies on top of the ceramic coating rather than being intercalated between the particles as in the slip-coated polymer membranes. That is, the particles may act as a mechanical barrier to limit swelling.

It was found that polymer membranes coated by the slip coating process showed significant infiltration of the membrane polymer into the ceramic. Thus, though the slip-coated membranes were found to be more highly selective, the increased selectivity may be counterbalanced by sacrifices in flux capacity. In the opposite direction, it was found that the polymer membrane coated by emulsion coating showed less infiltration. In this regard, the emulsion-coated porous supports may be more compatible with applications requiring high flux capacity with less importance on selectivity.

### Example 5

### Preparation of DENO/D400 with Amine Functionalized Fumed Silica

Amine Functionalized Fumed Silica was prepared for addition to a pre-polymer emulsion for applying polymer membranes to porous supports. To prepare the functionalized silica, 0.2 g of fumed silica (Sigma-Aldrich) having a nominal particle size of 0.014 μm, an aggregate size of several microns, and a 200 m²/g surface area was combined with 20 mL toluene in a 50-mL Teflon® screw-cap centrifuge tube with stirbar. A catalyst, 0.1 mL of ethylenediamine, was added, and the contents were mixed for 2 hours. A silane was added, namely 0.1 mL of aminopropyldimethylethoxysilane (“APDMES”), with continued stirring. The sealed tube was heated to 80° C. for 2 hours and then cooled to room temperature. The suspension was then centrifuged at 6000 rpm for 15 minutes, decanted. The resulting gel was washed twice, with resuspending with 10 mL toluene and centrifuging being part of each wash. The amine functionalized gel, “APDMES-SiO₂,” was stored under nitrogen. A small sample was dried overnight and found to contain 6.05% solids.

A suspension of the amine functionalized gel was made by suspending 1.81 g of the gel in 17.21 g of the 12.5 wt % DENO/D400 polymer precursor solution in toluene described in Example 1. The suspension was ultrasonically vibrated for 3 minutes. The viscosity of the final suspension was 1.6 cP, with 0.577 wt. % APDMES-SiO₂, 11.3 wt. % D400-DENO in toluene. A 2 g sample was distributed in an aluminum weighing pan, dried and cured 3 hours at 150° C. resulting in 0.23 g hazy polymer with no cracks evident. The concentration of silica in the cured polymer was calculated to be 4.9%.

### Example 6

### Coating of Porous Support with APDMES-SiO₂ in D400/DENO

A single channel, 2-inch long alumina-coated mullite monolith with channel diameters of 1.6 mm to 1.8 mm and a porosity of 0.2 μm was slip coated with the APDMES-SiO₂/D400/DENO solution prepared in Example 5 to obtain silica-polymer-ceramic membrane composites. The ends of all channels in the monolith were blocked by filling with a dense epoxy-ceramic filler, with the exception of the center channel which remained open at both ends. The open channel was filled with the polymer solution against a N₂ back-pressure of 16 kPa and vibrated ultrasonically 30 seconds. No bubbles of gas were observed. The polymer solution was drained, the porous support was dried overnight at ambient conditions, and was cured at 150° C. for 3 hours. Only 0.02 g of weight gain after the first coating was observed, and the coated monolith did not hold vacuum. Three additional coatings were made using the same procedure, with a final total weight gain of 0.13 g. The vacuum test gave a pressure increase of 6.3 kPa/min from 10 kPa over 10 minutes, indicating that the membrane was vacuum-tight.

### Example 7

### Pervaporation Testing

The silica-polymer coated support prepared in Example 6 was evaluated for pervaporation. The membrane was evaluated using a model feed having the composition 10 wt. % ethanol, 45 wt. %, toluene, and 45 wt. % n-heptane. The test support was mounted horizontally. Feed was supplied at 1.0 mL/minute, mixed with retentate recycle at about 500 mL/min, and heated to obtain the operating temperature prior to the membrane. Pervaporation test conditions were established with 1.0 mL/minute feed at 650 kPa(abs) pressure and a membrane temperature of 140° C. Vacuum was applied by means of a vacuum pump to obtain a permeate pressure of ˜0.5 kPa. Permeate product was collected over dry ice and was analyzed by gas chromatography.

The initial performance and stability of the membrane was determined at 140° C. Tests were conducted over a period of 540 hours. The membrane was cooled to ambient temperature and feed rate stopped at the end of each daily run. The total time spent at 140° C. was about 43 hours. After an initial line-out period the flux rate stabilized at about 0.89 g/s·m². Permeate yield on feed was 1.8% (w/w). The permeate composition (w/w) was determined to be 9.2% n-heptane, 37.7% toluene, and 53.2% ethanol. Selectivity for toluene relative to n-heptane was 4.1, and for total ethanol plus toluene relative to n-heptane was 8.1.

### Example 8

### Characterization of Porous Support with APDMES-SiO₂ in D400/DENO

The composite membrane used in Example 7 was removed from the test unit and characterized by optical microscopy and SEM. Optical microscopy revealed a dark membrane coating on the surface of the open center channel of the monolith. In cross section, infiltration of at least a portion of the polymer precursor solution occurred. SEM of the used membrane shows a polymer film of about 4 μm thickness, with minimal indication of infiltrated polymer on the underlying support particles. Many small particles (of silica) were apparent in the polymer film. The particles appeared to be completely encapsulated by the polymer.

In a first aspect, the disclosure provides a method for preparing a polymer membrane 80 on a porous support 10. The method includes providing a porous support 10 having an outer wall 20, a first end 30, a second end 40, and porous channel surfaces 50, 60 that define a plurality of channels 55, 65 through the porous support 10 from the first end 30 to the second end 40. The plurality of channels 55, 65 includes membrane channels 65 defined by membrane-channel surfaces 60. The method further may include establishing a pressure differential between the outer wall 20 and the plurality of channels 55, 65. The method may include applying a pre-polymer coating solution to at least the membrane-channel surfaces 60 while maintaining the pressure differential to form a pre-polymer layer on the membrane-channel surfaces 60. The method may include curing the pre-polymer layer to form the polymer membrane 80.

In a second aspect, the disclosure provides a method for preparing a polymer membrane 80 on a porous support 10 according to the first aspect, in which the porous support 10 is a honeycomb monolith.

In a third aspect, the disclosure provides a method for preparing a polymer membrane 80 on a porous support 10 according to the first or second aspect, in which the porous support 10 comprises a ceramic selected from cordierite, alpha-alumina, mullite, titania, zirconia, ceria, and combinations thereof.

In a fourth aspect, the disclosure provides a method for preparing a polymer membrane 80 on a porous support 10 according to any one of the first through third aspects, in which the method further includes applying a precoat layer 70 to at least the membrane channel surfaces 60 before establishing the pressure differential and applying the pre-polymer coating solution. The precoat layer 70 may have a precoat average pore size less than a support average pore size of the membrane-channel surfaces 60.

In a fifth aspect, the disclosure provides a method for preparing a polymer membrane 80 on a porous support 10 according to the fourth aspect, in which the precoat layer comprises ceramic particles selected from the group consisting of cordierite, alumina, mullite, aluminum titanate, titania, zirconia, ceria, and combinations thereof.

In a sixth aspect, the disclosure provides a method for preparing a polymer membrane 80 on a porous support 10 according to any one of the first through fifth aspects, in which the pre-polymer coating solution is applied to the membrane-channel surfaces 60, the first end 30, and the second end 40, and the pre-polymer layer forms on membrane-channel surfaces 60, the first end 30, and the second end 40.

In a seventh aspect, the disclosure provides a method for preparing a polymer membrane 80 on a porous support 10 according to any one of the first through sixth aspects, in which establishing the pressure differential comprises placing the porous support 10 in a coating vessel 100 having a chamber 120 defined therein between a first seal 130 at the first end 30 of the porous support 10 and a second seal 140 at the second end 40 of the porous support 10. At least a portion of the outer wall 20 of the porous support 10 is disposed in the chamber 120, and both the first end 30 and the second end 40 of the porous support 10 is outside the chamber 120. Thereby, fluidic communication between the plurality of channels 55, 65 and the chamber 120 occurs only through the outer wall 20. The method according to the seventh aspect may further include applying a vacuum or a backpressure to the chamber 120.

In an eighth aspect, the disclosure provides a method for preparing a polymer membrane 80 on a porous support 10 according to the seventh aspect, in which the coating vessel 100 includes a first port 170 coupled to the first end 30 of the porous support 10. A second port 180 is coupled to the second end 40 of the porous support 10, such that fluidic communication between the first port 170 and the second port 180 occurs through the plurality of channels 55, 65. A third port 190 is coupled to the chamber 120, such that fluidic communication between the third port 190 and the first and second ports 170. 180 occurs only through the outer wall 20 of the porous support 10.

In a ninth aspect, the disclosure provides a method for preparing a polymer membrane 80 on a porous support 10 according to any one of the first through eighth aspects, in which the pre-polymer coating solution comprises a polymer precursor in a water-immiscible organic solvent.

In a tenth aspect, the disclosure provides a method for preparing a polymer membrane 80 on a porous support 10 according to any one of the first through ninth aspects, in which the pre-polymer coating solution comprises a polymer precursor in a water-immiscible organic solvent.

In an eleventh aspect, the disclosure provides a method for preparing a polymer membrane 80 on a porous support 10 according to any one of the seventh through tenth aspects, in which establishing the pressure differential comprises applying a backpressure to the chamber 120.

In a twelfth aspect, the disclosure provides a method for preparing a polymer membrane 80 on a porous support 10 according to the tenth or eleventh aspect, in which the polymer precursor comprises an epoxy-diamine mixture of 1,2,7,8-diepoxyoctane and O,O′-bis(2-aminopropyl)propylene glycol monomers or oligomers.

In a thirteenth aspect, the disclosure provides a method for preparing a polymer membrane 80 on a porous support 10 according to the twelfth aspect, in which the polymer precursor further comprises amine-functionalized silica particles suspended in the epoxy-diamine mixture.

In a fourteenth aspect, the disclosure provides a method for preparing a polymer membrane 80 on a porous support 10 according to any one of the first through tenth aspects, in which the pre-polymer coating solution is an oil-in-water emulsion comprising an aqueous phase; an oil phase dispersed in the aqueous phase and containing the polymer precursor in the water-immiscible organic solvent; and a surfactant.

In a fifteenth aspect, the disclosure provides a method for preparing a polymer membrane 80 on a porous support 10 according to any one of the seventh through tenth aspects, in which establishing the pressure differential comprises applying a vacuum to the chamber 120.

In a sixteenth aspect, the disclosure provides a method for preparing a polymer membrane 80 on a porous support 10 according to the fourteenth or fifteenth aspects, in which the membrane-channel surfaces 60 have a membrane-channel pore-size distribution and the oil-in-water emulsion comprises oil-phase particles having an oil-phase particle size distribution substantially overlapping the membrane-channel pore-size distribution.

In a seventeenth aspect, the disclosure provides a method for preparing a polymer membrane 80 on a porous support 10 according to any one of the fourteenth through sixteenth aspects, in which the polymer precursor comprises an epoxy-diamine mixture of 1,2,7,8-diepoxyoctane and O,O′-bis(2-aminopropyl)propylene glycol monomers or oligomers.

In an eighteenth aspect, the disclosure provides a method for preparing a polymer membrane 80 on a porous support 10 according to any one of the fourteenth through seventeenth aspects, in which the surfactant comprises sodium dodecyl sulfate or an ethoxylated nonionic surfactant.

In a nineteenth aspect, the disclosure provides a method for preparing a polymer membrane 80 on a porous support 10 according to any one of the fourteenth through eighteenth aspects, in which the oil-in-water emulsion comprises from 0.1 wt. % to 10 wt. % of the oil phase based on the total weight of the oil-in-water emulsion, wherein the oil phase comprises from 10 wt. % to 50 wt. % of the polymer precursor, based on the total weight of the oil phase. The oil-in-water emulsion also comprises from 0.1 wt. % to 10 wt. % surfactant, based on the total weight of the oil-in-water emulsion.

In a twentieth aspect, the disclosure provides a method for preparing a polymer membrane 80 on a porous support 10 according to any one of the fourteenth through nineteenth aspects, in which the polymer precursor comprises an epoxy-diamine mixture of 1,2,7,8-diepoxyoctane and O,O′-bis(2-aminopropyl)propylene glycol monomers or oligomers; the oil-in-water emulsion comprises from 0.2 wt. % to 1 wt. % surfactant, based on the total weight of the oil-in-water emulsion; and the surfactant comprises sodium dodecyl sulfate.

In a twenty-first aspect, the disclosure provides a method for preparing a polymer membrane 80 on a porous support 10 according to any one of the fourteenth through twentieth aspects, in which the surfactant comprises an ethoxylated nonionic surfactant.

In a twenty-second aspect, the disclosure provides a method for preparing a polymer membrane 80 on a porous support 10 according to the twenty-first aspect, in which the ethoxylated nonionic surfactant is selected from the group consisting of (a) condensation products from reacting ethylene oxide with a hydrophobic base formed by the condensation of propylene oxide and propylene glycol; (b) condensation products from reacting ethylene oxide with a molecule formed by reacting propylene oxide and ethylenediamine; and (c) mixtures of (a) and (b).

In a twenty-third aspect, the disclosure provides a method for preparing a polymer membrane 80 on a porous support 10 according to any one of the fifteenth through twentieth-second aspects, in which a vacuum of from about −5 kPa to about −100 kPa is applied to the chamber 120.

In a twenty-fourth aspect, the disclosure provides a method for preparing a polymer membrane 80 on a porous support 10 according to any one of the first through twenty-third aspects, in which from 2 to 10 additional layers of polymer membrane are applied over the polymer membrane 80 by repeating the application of pre-polymer coating solution and curing of the pre-polymer layer after curing the polymer membrane 80.

In a twenty-fifth aspect, the disclosure provides a method for preparing a polymer membrane 80 on a porous support 10 according to any one of the first through twenty-third aspects, in which the method further includes applying a precoat layer 70 to at least the membrane channel surfaces 60 before establishing the pressure differential and applying the pre-polymer coating solution.

In a twenty-sixth aspect, the disclosure provides a method for preparing a polymer membrane 80 on a porous support 10 according to the twenty-fifth aspect, in which the support average pore size is from about 0.5 μm to about 100 μm and the precoat average pore size is from about 0.3 μm to about 1 μm.

In a twenty-seventh aspect, the disclosure provides a method for preparing a polymer membrane 80 on a porous support 10 according to any one of the first through twenty-sixth aspects, in which the polymer membrane 80 formed by the method is impervious to a vacuum of at least −50 kPa applied to the first end 30 and the second end 40 of the coated porous support 10.

In a twenty-eighth aspect, the disclosure provides a method for preparing a polymer membrane 80 on a porous support 10 according to any one of the first through twenty-seventh aspects, in which the curing comprises heating the porous support 10 to a curing temperature of from about 120° C. to about 180° C. for a curing time of from about 4 hours to about 18 hours.

In a twenty-ninth aspect, the disclosure provides a method for preparing a polymer membrane 80 on a porous support 10 according to any one of the first through twenty-eighth aspects, in which the method further comprises rinsing the channel surfaces (50, 60) with water between applying the pre-polymer solution and curing the pre-polymer layer

In a thirtieth aspect, the disclosure provides a method for preparing a polymer membrane 80 on a porous support 10 according to any one of the first through twenty-ninth aspects, in which the polymer membrane 80 is less than 20 μm thick.

In a thirty-first aspect, the disclosure provides a method for preparing a polymer membrane 80 on a porous support 10 according to any one of the first through thirtieth aspects, in which at least the membrane channels 65 are prefilled with a solvent before the pre-polymer coating solution is applied.

In a thirty-second aspect, the disclosure provides a polymer-membrane coated porous support prepared by the method according to any one of the first through thirty-first aspects.

In a thirty-third aspect, the disclosure provides a pervaporation system or apparatus containing at least one polymer-membrane coated porous support of the thirty-second aspect.

It should be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method for preparing a polymer membrane on a porous support, the method comprising:
providing a porous support having an outer wall, a first end, a second end, and porous channel surfaces that define a plurality of channels through the porous support from the first end to the second end, the plurality of channels comprising membrane channels defined by membrane-channel surfaces;
establishing a pressure differential between the outer wall and the plurality of channels;
applying a pre-polymer coating solution to at least the membrane-channel surfaces while maintaining the pressure differential to form a pre-polymer layer on the membrane-channel surfaces; and
curing the pre-polymer layer to form the polymer membrane.

2. The method of claim 1, wherein the porous support is a honeycomb monolith.

3. The method of claim 1, wherein the porous support comprises a ceramic selected from cordierite, alpha-alumina, mullite, titania, zirconia, ceria, and combinations thereof.

4. The method of claim 1, further comprising applying a precoat layer to at least the membrane channel surfaces before establishing the pressure differential and applying the pre-polymer coating solution, the precoat layer having a precoat average pore size less than a support average pore size of the channel surfaces.

5. The method of claim 4, wherein the precoat layer comprises ceramic particles selected from the group consisting of cordierite, alumina, mullite, aluminum titanate, titania, zirconia, ceria, and combinations thereof.

6. The method of claim 1, wherein the pre-polymer coating solution is applied to the membrane-channel surfaces, the first end, and the second end, and the pre-polymer layer forms on membrane-channel surfaces, the first end, and the second end.

7. The method of claim 1, wherein establishing the pressure differential comprises:
placing the porous support in a coating vessel having a chamber defined therein between a first seal at the first end of the porous support and a second seal at the second end of the porous support, at least a portion of the outer wall of the porous support being disposed in the chamber, both the first end and the second end of the porous support being outside the chamber, whereby fluidic communication between the plurality of channels and the chamber occurs only through the outer wall; and
applying a vacuum or a backpressure to the chamber.

8. The method of claim 7, wherein the coating vessel comprises:
a first port coupled to the first end of the porous support;
a second port coupled to the second end of the porous support, such that fluidic communication between the first port and the second port occurs through the plurality of channels; and
a third port coupled to the chamber, such that fluidic communication between the third port and the first and second ports occurs only through the outer wall of the porous support.

9. The method of claim 1, further comprising:
repairing defects in the polymer membrane by:
applying at least one additional layer of pre-polymer coating solution to the polymer membrane to form an defect-repair layer on the polymer membrane; and
curing the defect-repair layer to form a repaired polymer membrane.

10. The method of claim 1, wherein the pre-polymer coating solution comprises a polymer precursor in a water-immiscible organic solvent.

11. The method of claim 10, wherein establishing the pressure differential comprises applying a backpressure to the chamber.

12. The method of claim 11, wherein the polymer precursor comprises an epoxy-diamine mixture of 1,2,7,8-diepoxyoctane and O,O′-bis(2-aminopropyl)propylene glycol monomers or oligomers.

13. The method of claim 11, wherein the polymer precursor further comprises amine-functionalized silica particles suspended in the epoxy-diamine mixture.

14. The method of claim 10, wherein the pre-polymer coating solution is an oil-in-water emulsion comprising:
an aqueous phase;
an oil phase dispersed in the aqueous phase and containing the polymer precursor in the water-immiscible organic solvent; and
a surfactant.

15. The method of claim 14, wherein establishing the pressure differential comprises applying a vacuum to the chamber.

16. The method of claim 14, wherein the membrane-channel surfaces have a membrane-channel pore-size distribution and the oil-in-water emulsion comprises oil-phase particles having an oil-phase particle size distribution substantially overlapping the membrane-channel pore-size distribution.

17. The method of claim 14, wherein the polymer precursor comprises an epoxy-diamine mixture of 1,2,7,8-diepoxyoctane and O,O′-bis(2-aminopropyl)propylene glycol monomers or oligomers.

18. The method of claim 14, wherein the surfactant comprises sodium dodecyl sulfate or an ethoxylated nonionic surfactant.

19. The method of claim 14, wherein the oil-in-water emulsion comprises:
from 0.1 wt. % to 10 wt. % of the oil phase based on the total weight of the oil-in-water emulsion, wherein the oil phase comprises from 10 wt. % to 50 wt. % of the polymer precursor, based on the total weight of the oil phase; and
from 0.1 wt. % to 10 wt. % surfactant, based on the total weight of the oil-in-water emulsion.

20. The method of claim 19, wherein:
the polymer precursor comprises an epoxy-diamine mixture of 1,2,7,8-diepoxyoctane and O,O′-bis(2-aminopropyl)propylene glycol monomers or oligomers;
the oil-in-water emulsion comprises from 0.2 wt. % to 1 wt. % surfactant, based on the total weight of the oil-in-water emulsion; and
the surfactant comprises sodium dodecyl sulfate.
